(19) United States
(12) Patent Application Publication
(10) Pub. No.: US 2004/0003151 A1
(43) Pub. Date: Jan. 1, 2004

(54) Method and system for streaming transfer of data between a digital camera and a host

(75) Inventors: John D. Bateman, San Francisco, CA (US); Timothy D. Dieckman, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 10/188,164

(22) Filed: Jul. 1, 2002

(51) Int. Cl. G06F 13/12

(52) U.S. Cl. 710/72

(57) ABSTRACT

A method and a system for interacting with data transferred between a peripheral device and an intelligent host, including connecting the peripheral device with the host; initiating a transfer of the data between the peripheral device and the host; completing the transfer of a first data file of the data between the peripheral device and the host; and interacting with the first data file, while continuing the transfer of the remaining data files between the peripheral device and the host. In an embodiment, the peripheral device includes a digital camera, preferably a digital dual mode camera and the data being transferred includes digital still and/or digital video image data. The interaction with the data includes displaying, copying, printing and the sending of the data file to another location. The method also includes interacting with the next completely transferred data file, once the next data file has been completely transferred, while interacting with the first data file and while continuing the transfer of the remaining data files between the peripheral device and the host.

### BACKGROUND OF THE INVENTION

The present invention relates to digital cameras. More particularly, the present invention is directed towards methods and systems for the transfer of image data between a digital still camera and an intelligent host such as a personal computer.

Digital still cameras typically use an image sensor to capture an image of a scene and use electronic memory devices to store the captured images as image files on the camera. Digital still cameras are commercially available from many manufacturers as either stand alone digital still cameras or as a feature on digital video cameras. Digital still cameras are also available as a feature of dual-purpose cameras. Dual-purpose cameras, when connected with an intelligent host such a personal computer function as Internet video cameras, which are also know as web cams. When detached from the intelligent host, the dual-purpose camera functions as a digital still or video camera. The camera's control panel allows its operator to snap, save and delete pictures.

An essential factor of the commercial success of digital cameras is their ease of use. An essential aspect of the ease of use of a digital camera is the ease of transferring image data from the camera to a host. Typical dual-purpose cameras rely on a connection, such as a USB connection to transfer images, captured while in their detached mode, from the camera's memory to the host. Most consumers do not, on a regular basis, repeatedly connect, disconnect and reconnect a device such as a digital camera with their personal computers, and hence may find this aspect of the use of a digital camera rather cumbersome. Moreover, once a connection between a camera and its host has been established, the operator must maneuver through various menus of an application program to select, preview and transfer image data from the camera to its host. Presently, both the connection and data transfer operations are at best difficult to maneuver.

Some have provided improvements in the areas of data transfer from a digital camera. One such improvement is described in U.S. Pat. No. 6,167,469, entitled “Digital Camera Having Display Device for Displaying Graphical Representation of User Input and Method for Transporting the Selected Images Thereof.” The '469 patent provides a method and apparatus for the transfer of image data directly to a communication network without requiring the camera to be interfaced with a local host computer. The method of the '469 patent relies on an executable program resident on the camera to send image data from the camera to a destination over a communication network. The motivation for the '469 patent appears to be that many who own digital cameras may not own or may not have access to a local host computer to transfer their camera's image data to a destination. Thus the '469 patent requires the camera device to have the necessary hardware, firmware and software to achieve the data transfer operation. Such requirements generally tend to add complexity and cost to the camera device itself, which may impede the proliferation of such devices. Further, many who use digital cameras, also wish to edit the captured images on their local computers, and thus require a transfer of image data from a camera to a host.

Currently the transfer of image data from a digital camera to a host computer is performed either manually or automatically. A manual transfer requires some user intervention, while an automatic transfer requires less user intervention. While an automatic transfer is preferred because it requires less user intervention, an automatic transfer tends to be somewhat non-intelligent. This automatic transfer is non-intelligent because all the image data stored in the digital camera is sent to the host computer sequentially, for example, in the order in which the images were acquired. This transfer will require the operator to wait a while before the operator can begin to interact with the downloaded (e.g., from the camera to the host) images.

In addition, as fixed or removable memory devices continue to get cheaper, and thus enable an operator to capture more images, the transfer of image data to the host computer will also get more time consuming and more cumbersome, requiring the operator to wait even longer before the operator can interact with the downloaded images.

There is therefore a need to improve the data transfer operations between a digital camera and its host, especially to enable an operator to begin interacting with the transferred data more quickly.

### BRIEF SUMMARY OF THE INVENTION

The present invention provides a method and a system for interacting with data transferred between a peripheral device and an intelligent host, including connecting the peripheral device with the host; initiating a transfer of the data between the peripheral device and the host; completing the transfer of a first data file of the data between the peripheral device and the host; and interacting with the first data file, while continuing the transfer of the remaining data files between the peripheral device and the host. In an embodiment, the peripheral device includes a digital camera, preferably a digital dual mode camera and the data being transferred includes digital still and/or digital video image data. The interaction with the data includes displaying, copying, printing and the sending of the data file to another location. The method also includes interacting with the next completely transferred data file, once the next data file has been completely transferred, while interacting with the first data file and while continuing the transfer of the remaining data files between the peripheral device and the host.

Another aspect of the invention is directed to a system for interacting with data transferred between a peripheral device and an intelligent host, including a peripheral device configured to be connected with the host; a computer readable device having computer readable code embodied therein, the code embodying instructions for causing a transfer of data between the peripheral device and the host, the instructions including: instructions for initiating a transfer of the data between the peripheral device and the host; instructions for recognizing the completion of the transfer of a first data file of the data between the peripheral device and the host; and instructions for interacting with the first data file, including instructions for continuing the transfer of the remaining data files between the peripheral device and the host.

In an embodiment of the system, the peripheral device includes a digital camera, preferably a digital dual mode camera, and the data being transferred includes digital still and/or digital video image data. In certain embodiments, the instructions for interaction with the data include instructions for displaying, copying, modifying, printing and the sending of the data file to another location. The instructions also include instructions for interacting with the next completely transferred data file, once the next data file has been completely transferred to/from the host computer, including instructions for interacting with the first data file and while continuing the transfer of the remaining data files from/to the peripheral device to the host.

These and other embodiments of the present invention, as well as its advantages and features, are described in more detail in conjunction with the description below and attached figures.

### BRIEF DESCRIPTION OF THE DRAWINGS

FIG. 1 is a block diagram of a system for the transfer of data between a peripheral device and an intelligent host incorporating the method for the streaming transfer of data in accordance with the present invention.

FIG. 2 is a block diagram of an embodiment of a method for the streaming transfer of data between a peripheral device and a host computer in accordance with the present invention.

FIG. 3A is diagram of one embodiment of a computer system for executing a software program incorporating the described method for the streaming transfer of data in accordance with the present invention.

FIG. 3B is a simplified system block diagram of a typical computer system used to execute a software program incorporating the described method for the streaming transfer of data in accordance with the present invention.

### DETAILED DESCRIPTION OF THE INVENTION

Embodiments of the present invention are directed to methods and systems for the transfer of data between a peripheral device and a local or a remote host. More specifically, the peripheral device includes a digital camera, where the digital camera may be a stand-alone digital camera or a dual mode digital camera and the data comprises digital image data that is stored on the camera. Furthermore, data stored on the camera can include audio in addition to image data. As used herein, digital image data includes both digital still and video image data. A dual mode digital camera is a digital camera that operates in at least two modes, where in a first mode, the camera is a stand alone digital still or video camera, and in a second mode, the camera is a digital still or video camera connected to its host computer, which is also commonly known as an Internet video camera or a web cam. The local or remote host is most commonly a personal computer. However, since advancements in technology are blurring the boundaries between computing and communication devices, a host as used herein is meant to include other examples of any host such as, for example, one having a processor, memory, means for input and output, and means for storage. Other examples of hosts, which are also equally qualified to be used in conjunction with embodiments of the present invention include a server computer, a handheld computer, an interactive set-top box, a thin client computing device, a personal access device, a cellular or wireless telephone, an internet appliance and an internet connected digital picture frame.

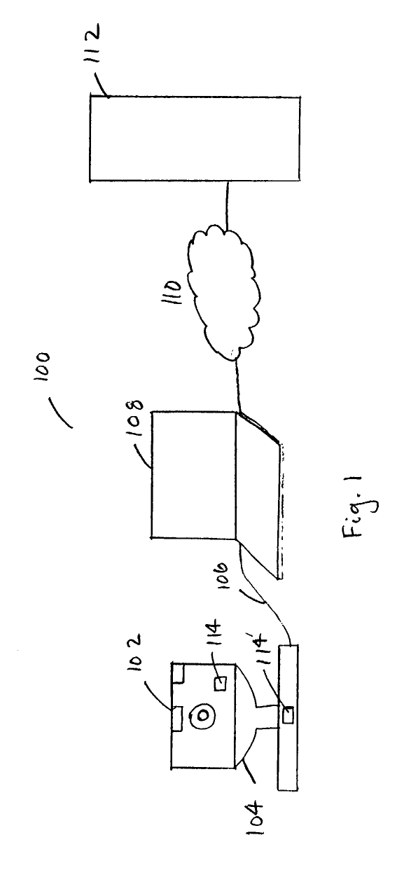

FIG. 1 is a top-level block diagram a system 100 for the transfer of data between a peripheral device 102 and an intelligent host 108 incorporating the method described below for the streaming transfer of data in accordance with the present invention. In one embodiment, the peripheral device 102 includes a digital camera which may also be a dual mode digital camera, which may be connected with a base or a cradle 104. The cradle 104 is connected with a local host 108 via a connection 106 through an external bus such as a Universal Serial Bus (USB). The connection between the camera base unit and the host includes both tethered and wireless connections; where in the wireless case, the base unit is capable of wirelessly transmitting to and receiving data from the intelligent host. Alternately, the camera may be connected with a host directly and without a cradle or a base. Yet alternately, the camera may be configured with a built-in wireless transceiver for communication with a host, and further configured such that once the camera is brought within the range of a host transceiver, the data transfer is initiated without any further operator intervention and/or without needing a cradle or base for such a transfer. Furthermore, the local host 108 may be connected via an Internet connection 110 to a remote intelligent host 112. The remote host 112 can also be a remote file server hosting a web site.

Image data captured by the camera 102 is selected and various actions are assigned to each selected image by an operator of the camera. The image selection and action assignment operations, include selecting an image to be transferred to a host and selecting an image to be further processed by a host, where further processing by a host can include printing a selected image or forwarding a selected image to a remote host, or an electronic mail recipient. The capturing of images and the image selection and action assignment operations are carried out by an operator of the camera in its disconnected (still or video) mode, while it is disconnected from the cradle 104. The operator captures images, selects images and assigns actions to the selected images using on-camera software programs which are configured to carry out these operations and which receive input from various push buttons on the camera, which are activated by the camera operator. The on-camera software also enables the user to designate that all subsequently captured images are to be automatically assigned actions which are to be carried out when the camera is interfaced with the host.

On-camera and on-host software programs enable the transfer of selected image data from the camera 102 to the local host 108 or the remote host 112. In some embodiments the transfer of data from the camera 102 to the local host 108 or the remote host 112 is initiated in response to an operator pressing a button 114 on the camera 102, or alternately the button 114′ on the cradle 104. Alternately, the image transfer is initiated automatically after an interface between the camera and the host is recognized by the camera. Yet alternately, the image transfer is initiated, without user intervention, by the application software running on a local or remote host. In addition, the user may initiate the transfer by clicking a button in the application software. As used herein, the button 114 (or 114′) is referred to as the “quick send” button, since once the button is activated all the data selected for transfer out of the camera is send to the host without requiring any further input from the camera operator. Further details of such a camera and system, including the on-camera and on-host software operations as well as the image selection and action assignment are described in more detail in a copending U.S. patent application Ser. No. 09/882,533, assigned to the assignee herein and entitled, “METHOD AND SYSTEM FOR TRANSFERRING DATA BETWEEN A DIGITAL CAMERA AND A HOST,” the disclosure of which is herein incorporated by reference in its entirety for all purposes.

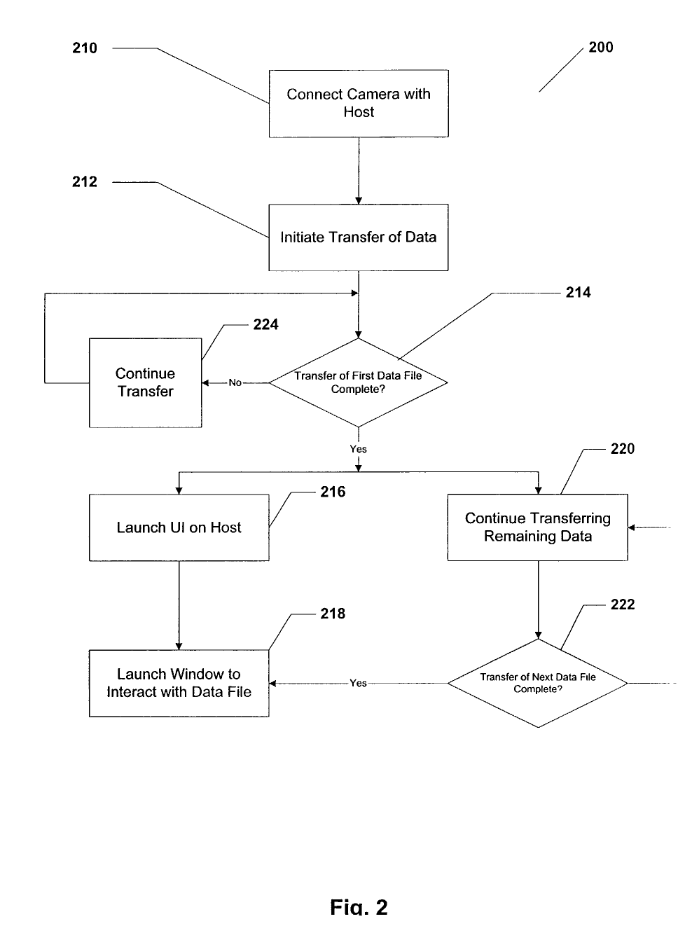

FIG. 2 is a block diagram of an embodiment of a method 200 for the streaming transfer of data between a digital camera and a host computer in accordance with the present invention. In describing one of the possible directions for the transfer of data between a peripheral device and a host, the description below is directed to the transfer of data from a device to a host. This description is meant to be illustrative and not limiting of the scope of the present invention, as the method for streaming transfer of data is equally embodied in a bi-directional transfer between a host and a peripheral device. In one embodiment involving the transfer of data from a device to a host, in order to stream image data from a digital camera to a host, the method begins by connecting a digital camera with a host computer (step 210). As described above, the connection of a camera with a host computer may be a tethered or a wireless connection and may include the use of a base or a cradle. Next, a transfer of the image data from the camera to the host is initiated (step 212). It is presumed that a software program or driver has been previously installed to enable the operations described herein. In an embodiment, the transfer includes the transfer of all the image data from the camera to the host. In one embodiment, the order in which the data is transferred may be a purely sequential one in either an ascending or descending order based on the order in which the image data was captured by the camera. In an alternate embodiment, the order of transfer is based on the file type, e.g., still or video. In another embodiment, the image transfer is based on the file size in an ascending or descending order of file size. Furthermore, the operator of the camera may select any of these transfer orders or establish his or her own transfer order using the camera's on-board software and its push buttons.

Once the camera is connected with the host (step 210) and the transfer of data is initiated (step 212), the computer-based method checks to see whether the transfer of a first portion (e.g., a first image data file) of image data from the camera to the host is completed (step 214). If the transfer of a first portion in not completed, the transfer of data is continued (step 224) until the transfer of a first portion is completed. Once the transfer of a first image data file (i.e., a first portion) is completed, the computer-based method next launches a user interface (UI) (step 216) and displays it (the first image data file) on the display device of a host computer (step 218). Alternately, the computer based method launches the UI while also initiating the transfer of data from the camera to the host. The UI will display several UI controls that allow an operator to interact with the downloaded or still to be downloaded images, while the transfer is underway. These UI controls include, for example, a download progress bar; a download options menu enabling naming preferences, bulk rescaling options as well as other download options such as color correction, resolution and so on; editing options enabling image cropping, video combining or stitching, addition of cosmetic frames to images, rescaling, rotating, drawing on the image, adding text, displaying a date/time stamp, cropping, etc.; email options menu; scroll control (e.g., forward and backward) for newly downloaded images.

Next, the computer based method, via the UI, launches a window to display the first completely transferred image data file to enable the operator to interact with the displayed image (step 218), while the transfer of the remaining image data files is continuing in the background (step 220). As used herein, an operator may interact with a displayed image, by viewing, selecting, resizing, editing, renaming, copying, printing, e-mailing it as an attachment, as well as other common image manipulations, as are known by those of skill in the art of image data editing.

As the transfer of the remaining image data files is continuing, the computer-based method continues to check for the completion of the transfer of the next image data file (step 222). Once the transfer of the next data file is completed, the next completely transferred image data file is displayed (e.g., optionally with a UI controls) (step 218). The transfer of the remaining image data files is continued, as well as the display of the next completely transferred image data file, until all images are transferred from the camera to the host computer.

In an alternate embodiment, the UI launches a new window for the display and enablement of interaction with each of the completely transferred image data files. In yet another alternate embodiment, once all the image data files are transferred to the host, the UI will launch a slide show and continuously, in continuous loop, display all the transferred image data files, until the continuous loop is interrupted by an operator action such as, for example, selecting one of the displayed image data files. Furthermore, the UI is configured to allow the user to step forward and/or backward in the UI through all of the currently transferred items.

Embodiments of the methods described above may be implemented as a software program. Such a software program may be written using a variety of programming languages, including C, C++, visual C, C#, Java, visual Java, and other languages as is known to those of skill in the art of peripheral communication programming.

Embodiments of the methods described above may be practiced in a multitude of different ways (i.e., software, hardware, or a combination of both) and in a variety of systems. In one embodiment, the described method can be implemented as a software program. The software program may be configured for execution by various computer systems or processors, including common computer entertainment systems (e.g., PlayStation™ series of game consoles, Nintendo™ series of game consoles including the Game Boy™ products) as well as personal computers (e.g., PC's and Macs), and other host types as described above.

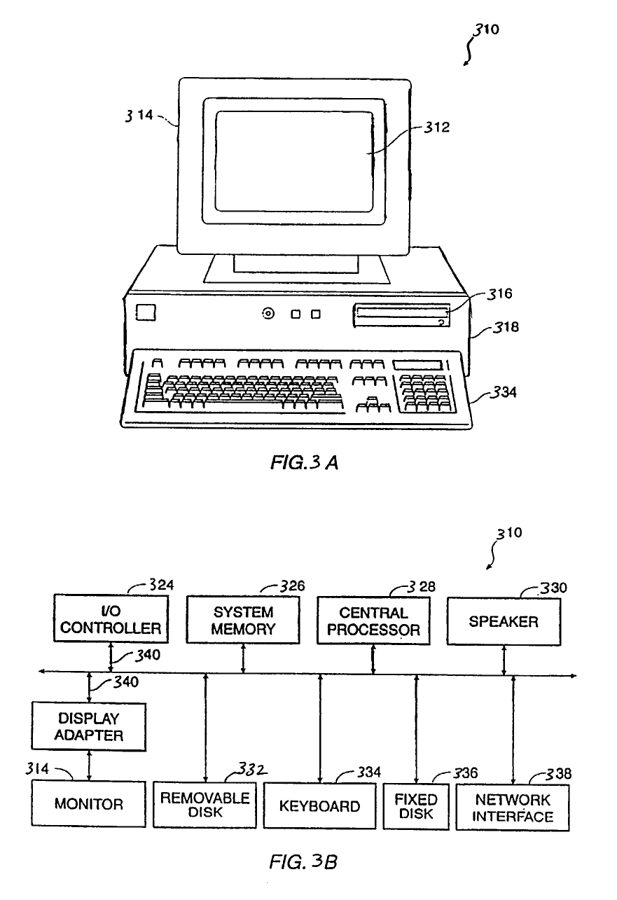

FIG. 3A is diagram of one embodiment of a computer system 310 for executing a software program incorporating the described method for the streaming transfer of data between a digital camera and a host computer in accordance with the present invention. Computer system 310 includes a monitor 314, screen 312, cabinet 318, and keyboard 334. A mouse, light pen, a joy stick, a gamepad, a wheel or other I/O interfaces, such as virtual reality interfaces may also be included (not shown) for providing I/O commands. Cabinet 318 houses a CD-ROM drive 316, a hard drive (not shown) or other storage data mediums which may be utilized to store and retrieve digital data and software programs incorporating the present method, and the like. Although CD-ROM 316 is shown as the removable media, other removable tangible media including floppy disks, tape, flash memory, or game cartridges may be utilized. Cabinet 318 also houses familiar computer components (not shown) such as a processor, memory, and the like.

FIG. 3B illustrates a simplified system block diagram of a typical computer system used to execute a software program incorporating the described method for the streaming transfer of data between a digital camera and a host computer in accordance with the present invention. As shown in FIGS. 3A and 3B, computer system 310 includes monitor 314 which optionally is interactive with the I/O controller 324. Computer system 310 further includes subsystems such as system memory 326, central processor 328, speaker 330, removable disk 332, keyboard 334, fixed disk 336, and network interface 338. Other computer systems suitable for use with the described method may include additional or fewer subsystems. For example, another computer system could include more than one processor 328 (i.e., a multi-processor system) for processing the digital data. Arrows such as 340 represent the system bus architecture of computer system 310. However, these arrows 340 are illustrative of any interconnection scheme serving to link the subsystems. For example, a local bus could be utilized to connect the central processor 328 to the system memory 326. Computer system 310 shown in FIG. 3B is but an example of a computer system suitable for use with the present invention. Other configurations of subsystems suitable for use with the present invention will be readily apparent to one of ordinary skill in the art. These other systems include common computer entertainment systems (e.g., PlayStation™ series of game consoles, Nintendo™ series of game consoles including the Game Boy™ products) as well as personal computers (e.g., PC's and Macs), and other host types as described above.

Embodiments of the present invention offer several advantages as compared to other methods of transferring image data files between a digital camera and a host computer. In embodiments where the transfer of data is from the peripheral device (e.g., camera) to the host, the streaming transfer in accordance with embodiments of the present invention allows an operator of a digital camera to begin interacting with a downloaded image very quickly upon the completion of the transfer of a first image data file, while the remaining image data files continue to be transferred from the camera to the host computer in a background process. As a result, an operator of a camera is not daunted by having to wait a long time before he or she can begin to interact with downloaded images (from the camera to a host computer). Furthermore, the time period before which the interaction can begin may also be significantly shortened by choosing the order of file transfers to be based on the size of the file, such that the smallest files are transferred first.

As will be understood by those of skill in the art, the present invention may be embodied in other specific forms without departing from the essential characteristics thereof. For example, the UI may be launched at the same time that the transfer is initiated, or it may be launched after a first image data file has been completely transferred to the host from the camera. Or the files may be transferred from the camera to the host in sequence based on an ascending or descending order based on the time when the images were acquired, or alternately, the order of transfer may be based on an increasing or decreasing file size order. Or yet, the transfer of data may be in any direction between a peripheral device such as, for example, a camera and a host. Accordingly, the foregoing is intended to be illustrative, but not limiting of the scope of the invention, which is set forth in the following claims.

What is claimed is:

1. A method of interacting with data transferred between a peripheral device and an intelligent host, comprising:
connecting said peripheral device with said host;
initiating a transfer of said data from said peripheral device to said host;
completing the transfer of a first data file of said data from said peripheral device to said host; and
interacting with said first data file, while continuing the transfer of the remaining data files from said peripheral device to said host.

2. The method of claim 1 wherein said initiating a transfer of data comprises initiating a transfer of digital image data.

3. The method of claim 1 wherein said connecting said peripheral device comprises connecting a digital camera.

4. The method of claim 3 wherein said connecting a digital camera comprises connecting a dual mode digital camera having at least a first mode and a second mode of operation, wherein in said first mode said digital camera is a digital still camera, and in said second mode, said digital camera is a digital video camera.

5. The method of claim 1 wherein said connecting with said host comprises connecting with a host selected from the group consisting of a server computer, a personal computer, a handheld computer, an interactive set-top box, a thin client computing device, a personal access device, a cellular telephone, an internet appliance, an internet connected digital picture frame and combinations thereof.

6. The method of claim 1 wherein said interacting comprises displaying, editing, printing and further transmitting said data file.

7. The method of claim 1 further comprising interacting with the next completely transferred data file of said data, once said next data file has been completely transferred to said host, while interacting with said first data file.

8. A system for interacting with data transferred between a peripheral device and an intelligent host, comprising:
a peripheral device configured to be connected with said host;
a computer readable device having computer readable code embodied therein, said code embodying instructions for causing a transfer of data between said peripheral device and said host, said instructions comprising:
instructions for initiating a transfer of said data from said peripheral device to said host;
instructions for recognizing the completion of the transfer of a first data file of said data from said peripheral device to said host; and
instructions for interacting with said first data file after said data file has been completely transferred to said host, including instructions for continuing the transfer of the remaining data files from said peripheral device to said host.

9. The system of claim 8 wherein said data comprises digital image data.

10. The system of claim 8 wherein said peripheral device comprises a digital camera.

11. The system of claim 10 wherein said digital camera comprises a dual mode digital camera having at least a first mode and a second mode of operation, wherein in said first mode said digital camera is a digital still camera, and in said second mode, said digital camera is a digital video camera.

12. The system of claim 8 wherein said intelligent host is a host selected from the group consisting of a server computer, a personal computer, a handheld computer, an interactive set-top box, a thin client computing device, a personal access device, a cellular telephone, an internet appliance, an internet connected digital picture frame and combinations thereof.

13. The system of claim 8 wherein said instruction for interacting comprise instructions for displaying, editing, and further transmitting said data file.

14. The system of claim 8 wherein said instructions for causing a transfer of data further comprise instructions for interacting with the next completely transferred data file, once said next data file has been completely transferred to said host, while interacting with said first data file.

15. A method of interacting with data transferred between a peripheral device and an intelligent host, comprising:
connecting said peripheral device with said host;
initiating a transfer of said data between said peripheral device and said host;
completing the transfer of a first data file of said data between said peripheral device and said host; and
interacting with said first data file, while continuing the transfer of the remaining data files between said peripheral device and said host.

16. The method of claim 15 wherein said initiating a transfer of data comprises initiating a transfer of digital image data.

17. The method of claim 15 wherein said connecting said peripheral device comprises connecting a digital camera.

18. The method of claim 17 wherein said connecting a digital camera comprises connecting a dual mode digital camera having at least a first mode and a second mode of operation, wherein in said first mode said digital camera is a digital still camera, and in said second mode, said digital camera is a digital video camera.

19. The method of claim 15 wherein said connecting with said host comprises connecting with a host selected from the group consisting of a server computer, a personal computer, a handheld computer, an interactive set-top box, a thin client computing device, a personal access device, a cellular telephone, an internet appliance, an internet connected digital picture frame and combinations thereof.

20. The method of claim 15 wherein said interacting comprises displaying, editing, printing and further transmitting said data file.

21. The method of claim 15 further comprising interacting with the next completely transferred data file of said data, once said next data file has been completely transferred, while interacting with said first data file.

22. A system for interacting with data transferred between a peripheral device and an intelligent host, comprising:
a peripheral device configured to be connected with said host;
a computer readable device having computer readable code embodied therein, said code embodying instructions for causing a transfer of data between said peripheral device and said host, said instructions comprising:
instructions for initiating a transfer of said data between said peripheral device and said host;
instructions for recognizing the completion of the transfer of a first data file of said data between said peripheral device and said host; and
instructions for interacting with said first data file after said data file has been completely transferred, including instructions for continuing the transfer of the remaining data files between said peripheral device and said host.

23. The system of claim 22 wherein said data comprises digital image data.

24. The system of claim 22 wherein said peripheral device comprises a digital camera.

25. The system of claim 24 wherein said digital camera comprises a dual mode digital camera having at least a first mode and a second mode of operation, wherein in said first mode said digital camera is a digital still camera, and in said second mode, said digital camera is a digital video camera.

26. The system of claim 22 wherein said intelligent host is a host selected from the group consisting of a server computer, a personal computer, a handheld computer, an interactive set-top box, a thin client computing device, a personal access device, a cellular telephone, an internet appliance, an internet connected digital picture frame and combinations thereof.

27. The system of claim 22 wherein said instruction for interacting comprise instructions for displaying, editing, and further transmitting said data file.

28. The system of claim 22 wherein said instructions for causing a transfer of data further comprise instructions for interacting with the next completely transferred data file, once said next data file has been completely transferred, while interacting with said first data file.
